(19) United States
(12) Patent Application Publication
(10) Pub. No.: US 2023/0329460 A1
(43) Pub. Date: Oct. 19, 2023

(54) Blanket Assembly

(71) Applicant: Elaine Fenner, Killeen, TX (US)

(72) Inventor: Elaine Fenner, Killeen, TX (US)

(21) Appl. No.: 17/720,538

(22) Filed: Apr. 14, 2022

(51) Int. Cl. A47G 9/02; A61H 23/00

(52) U.S. Cl. CPC A47G 9/0223; A61H 23/00; A61H 2201/0134

(57) ABSTRACT

A blanket assembly for retaining body heat of a user includes a blanket. An aperture is positioned in an upper half of the blanket and substantially equally distant from opposed sides of the blanket. The aperture is sized substantially complementarily to a neck of a user. A slit extends from the aperture to an upper end of the blanket and defines a pair of flaps. The slit facilitates donning of the blanket by the user so that the neck of the user is positioned through the aperture and the flaps extend over shoulders of the user and at least partially down a back of the user. A pair of pouch panels is attached to a rear face of the blanket and defines a pair of pockets. Each pocket has an opening that faces a respective opposed side of the blanket. The hands of the user can be positioned in the pockets.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to blankets and more particularly pertains to a new blanket for retaining body heat of a user. The present invention discloses a blanket that fits comfortably around a seated user without significant bunching of the blanket. The hands of the user can be positioned in pockets attached to a rear of the blanket.

### (2) Description of Related Art including Information Disclosed Under 37 CFR 1.97 and 1.98.

The prior art relates to blankets. Prior art blankets may comprise blankets with apertures for heads and/or hands, blankets with head apertures and foot pockets, and blankets with head apertures and integral head pads. Prior art blankets also may comprise blankets with arcuate cutouts extending into their top edges. Related prior art includes blankets for use with children in car seats. What is lacking in the prior art is a blanket having an aperture that is positioned in its upper half with a slit extending from the aperture to an upper end of the blanket defines a pair of flaps that can extend over shoulders of the user and at least partially down a back of the user. Further lacking in the prior art is a pair of pouch panels, which is attached to a rear face of the blanket and defines a pair of pockets in which the user's hands can be positioned.

### BRIEF SUMMARY OF THE INVENTION

An embodiment of the disclosure meets the needs presented above by generally comprising a blanket. An aperture is positioned in an upper half of the blanket and substantially equally distant from opposed sides of the blanket. The aperture is sized substantially complementarily to a neck of a user. A slit extends from the aperture to an upper end of the blanket and defines a pair of flaps. The slit is configured to facilitate donning of the blanket by the user so that the neck of the user is positioned through the aperture and the flaps extend over shoulders of the user and at least partially down a back of the user. A pair of pouch panels is attached to a rear face of the blanket and defines a pair of pockets. Each pocket has an opening that faces a respective opposed side of the blanket. The pocket is configured for selective insertion of an associated hand of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a blanket assembly according to an embodiment of the disclosure.

FIG. 2 is a rear view of an embodiment of the disclosure.

FIG. 3 is an isometric perspective view of an embodiment of the disclosure.

FIG. 4 is an in-use view of an embodiment of the disclosure.

### DETAILED DESCRIPTION OF THE INVENTION

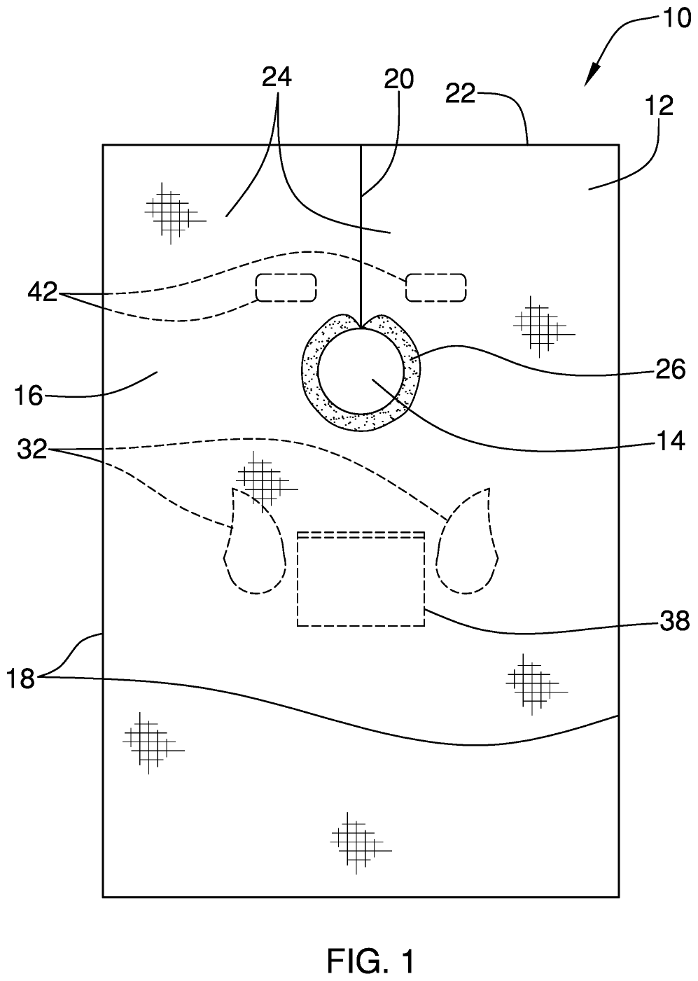

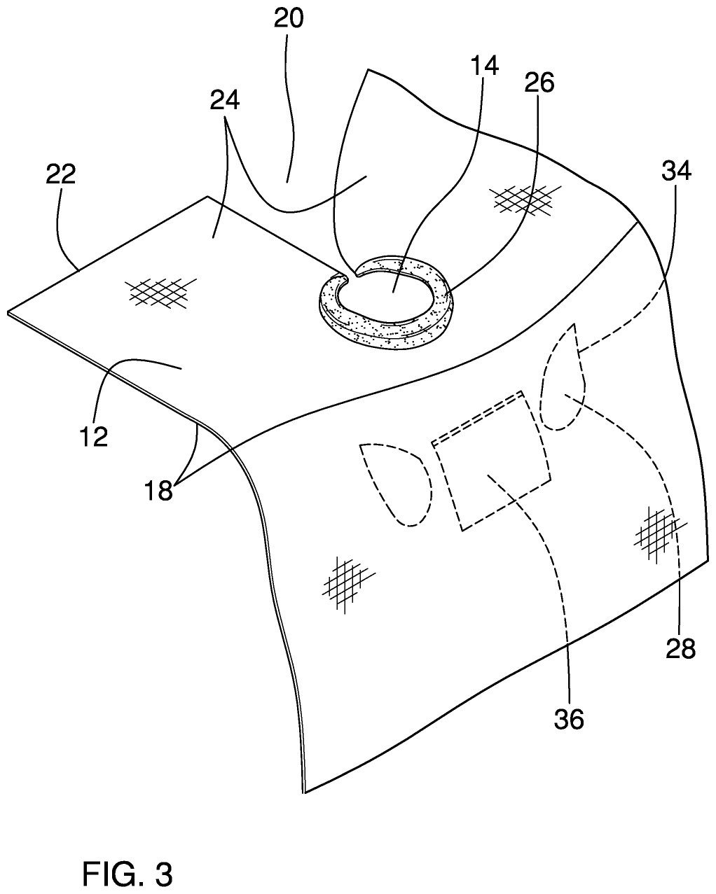

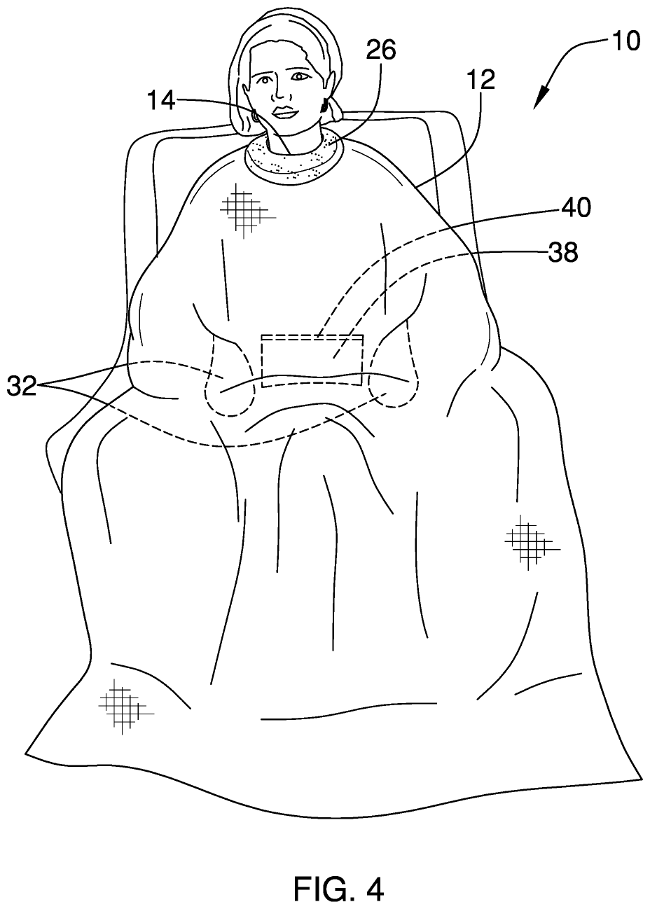

With reference now to the drawings, and in particular to FIGS. 1 through 4 thereof, a new blanket embodying the principles and concepts of an embodiment of the disclosure and generally designated by the reference numeral 10 will be described.

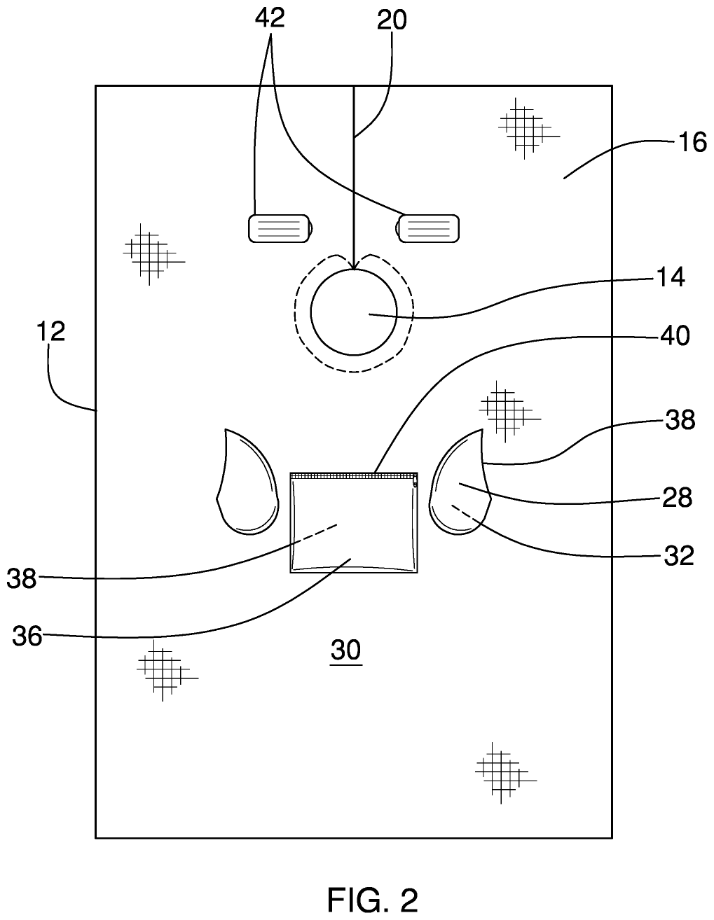

As best illustrated in FIGS. 1 through 4, the blanket assembly 10 generally comprises a blanket 12, which may be substantially rectangular, as is shown in FIGS. 1 and 2, or alternatively shaped, such as, but not limited to, elongated ovoid, circular, and the like. An aperture 14 is positioned in an upper half 16 of the blanket 12 and substantially equally distant from opposed sides 18 of the blanket 12. The aperture 14 is sized substantially complementarily to a neck of a user.

A slit 20 extends from the aperture 14 to an upper end 22 of the blanket 12 and defines a pair of flaps 24. The slit 20 is configured to facilitate donning of the blanket 12 by the user so that the neck of the user is positioned through the aperture 14 and the flaps 24 extend over shoulders of the user and at least partially down a back of the user.

A pad 26 is attached to the blanket 12 and extends circumferentially around the aperture 14. The slit 20 extends through the pad 26. The pad 26 is configured to support the neck of the user. The present invention anticipates the pad 26 being removably attached to the blanket 12 so that the blanket 12 and the pad 26 can be laundered separately.

A pair of pouch panels 28 is attached to a rear face 30 of the blanket 12 and defines a pair of pockets 32, which are positioned proximate to a waist of the user upon donning of the blanket 12. Each pocket 32 has an opening 34 that faces a respective opposed side 18 of the blanket 12 and thus is configured for selective insertion of an associated hand of the user. The pockets 32 can provide additional insulation for the hands and also a means of comfortably supporting arms of the user. The present invention also anticipates the pair of pouch panels 28 comprising a single pouch panel 28 that defines an open ended sleeve (not shown) into which the hands of the user could be inserted.

A rear panel 36 is attached to the rear face 30 of the blanket 12 and defines a storage pouch 38. The storage pouch 38 has an entry 40 that faces the aperture 14. The entry 40 may be zippered, as is shown in FIG. 2, or otherwise selectively closable, such as by means of a hook and loop fastener, or the like. The storage pouch 38 extends upwardly from proximate to the waist of the user upon donning of the blanket 12 and is configured to allow for stowing of an article, such as a snack, a remote control, a smartphone, or the like.

The blanket assembly 10 also may comprise a pair of vibrators 42, with the vibrators 42 being attached singly to the flaps 24. The vibrators 42 are positioned against the back of the user upon donning the blanket 12 and are configured to massage the back of the user.

In one example of use wherein the blanket assembly 10 is being utilized by a user seated in a chair, or the like, to cover themself, each of the flaps 24 is grasped in a hand of the user. The blanket 12 then is pulled upwardly so that the neck of the user passes through the slit 20 into the aperture 14. While leaning forward, the flaps 24 are released so that they drape over shoulders of the user and at least partially down the back of the user. When the user leans against a back of the chair, the blanket 12 is substantially fixed in position. A similar procedure would be employed by an assistant for a user who is seated but requires assistance in positioning the blanket 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A blanket assembly comprising:
a blanket;
an aperture positioned in an upper half of the blanket and substantially equally distant from opposed sides of the blanket, the aperture being sized substantially complementarily to a neck of a user;
a slit extending from the aperture to an upper end of the blanket defining a pair of flaps, wherein the slit is configured for facilitating donning of the blanket by the user, such that the neck of the user is positioned through the aperture and the flaps extend over shoulders of the user and at least partially down a back of the user; and
a pair of pouch panels attached to a rear face of the blanket defining a pair of pockets, each pocket having an opening, the opening facing a respective opposed side of the blanket, wherein the pocket is configured for selective insertion of an associated hand of the user.

2. The blanket assembly of claim 1, wherein the blanket is substantially rectangular.

3. The blanket assembly of claim 1, further including a pad attached to the blanket and extending circumferentially around the aperture, the slit extending through the pad, wherein the pad is configured for supporting the neck of the user.

4. The blanket assembly of claim 2, wherein the pocket is positioned proximate to a waist of the user upon donning of the blanket.

5. The blanket assembly of claim 1, further including a rear panel attached to the rear face of the blanket defining a storage pouch, the storage pouch having an entry facing the aperture, the storage pouch extending upwardly from proximate to the waist of the user upon donning of the blanket, wherein the storage pouch is configured for stowing of an article.

6. The blanket assembly of claim 5, wherein the entry is zippered.

7. The blanket assembly of claim 1, further including a pair of vibrators, each vibrator being attached to a respective flap, such that the vibrator is positioned against the back of the user upon donning the blanket, wherein the vibrator is configured for massaging the back of the user.

8. A blanket assembly comprising:
a blanket, the blanket being substantially rectangular;
an aperture positioned in an upper half of the blanket and substantially equally distant from opposed sides of the blanket, the aperture being sized substantially complementarily to a neck of a user;
a slit extending from the aperture to an upper end of the blanket defining a pair of flaps, wherein the slit is configured for facilitating donning of the blanket by the user, such that the neck of the user is positioned through the aperture and the flaps extend over shoulders of the user and at least partially down a back of the user;
a pad attached to the blanket and extending circumferentially around the aperture, the slit extending through the pad, wherein the pad is configured for supporting the neck of the user;
a pair of pouch panels attached to a rear face of the blanket defining a pair of pockets, each pocket having an opening, the opening facing a respective opposed side of the blanket, wherein the pocket is configured for selective insertion of an associated hand of the user, the pocket being positioned proximate to a waist of the user upon donning of the blanket;
a rear panel attached to the rear face of the blanket defining a storage pouch, the storage pouch having an entry facing the aperture, the storage pouch extending upwardly from proximate to the waist of the user upon donning of the blanket, wherein the storage pouch is configured for stowing of an article, the entry being zippered; and
a pair of vibrators, each vibrator being attached to a respective flap, such that the vibrator is positioned against the back of the user upon donning the blanket, wherein the vibrator is configured for massaging the back of the user.
